(19) United States
(12) Patent Application Publication
(10) Pub. No.: US 2026/0046611 A1
(43) Pub. Date: Feb. 12, 2026

(54) Control Frame Based Media Access Control Header Integrity Protection

(71) Applicant: Apple Inc., Cupertino, CA (US)

(72) Inventors: Jarkko L. Kneckt, Los Gatos, CA (US); Marina Sharkansky, Haifa (IL); Yong Liu, Campbell, CA (US); Charles F. Dominguez, Redwood City, CA (US); Su Khiong Yong, Palo Alto, CA (US); Yoel Boger, Shoham (IL); Leonid Epstein, Netanya (IL); Yanjun Sun, Cupertino, CA (US)

(21) Appl. No.: 19/216,135

(22) Filed: May 22, 2025

Related U.S. Application Data
(60) Provisional application No. 63/681,010, filed on Aug. 8, 2024.

(51) Int. Cl. H04W 8/26; H04L 1/1607; H04L 69/22; H04W 88/12

(52) U.S. Cl. CPC H04W 8/26; H04L 1/1621; H04L 69/22; H04W 88/12

(57) ABSTRACT

This disclosure relates to methods for control frame-based media access control header integrity protection in a wireless local area network. One or more media access control protocol data units can be generated. A control frame that includes media access control header content associated with the media access control protocol data unit(s) can be generated. The control frame can also include sequence number range information for the media access control protocol data unit(s). The control frame can also include integrity protection information for the media access control header content and sequence number range information. The control frame and the media access control protocol data unit(s) can be wirelessly transmitted.

### PRIORITY INFORMATION

This application claims priority to U.S. provisional patent application Ser. No. 63/681,010, entitled “Control Frame Based Media Access Control Header Integrity Protection,” filed Aug. 8, 2024, which is hereby incorporated by reference in its entirety as though fully and completely set forth herein.

### TECHNICAL FIELD

The present application relates to wireless communication, including techniques and devices for providing control frame based integrity protection for media access control header content in a wireless local area network architecture.

### DESCRIPTION OF THE RELATED ART

Wireless communication systems are ubiquitous. Further, wireless communication technology has evolved from voice-only communications to also include the transmission of data, such as Internet and multimedia content.

Mobile electronic devices, or stations (STAs) or user equipment devices (UEs), can take the form of smart phones or tablets that a user typically carries. One aspect of wireless communication that can commonly be performed by mobile devices can include wireless networking, for example over a wireless local area network (WLAN), which can include devices that operate according to one or more communication standards in the IEEE 802.11 family of standards. Protecting the integrity of such wireless communications without overly degrading communication efficiency from signaling overhead can be a significant challenge. Accordingly, improvements in the field are desired.

### SUMMARY

Embodiments are presented herein of, inter alia, systems, apparatuses, and methods for devices to provide control frame-based integrity protection for media access control header content in a wireless local area network architecture.

A wireless device can include one or more antennas, one or more radios operably coupled to the one or more antennas, and a processor operably coupled to the one or more radios. The wireless device can be configured to establish a connection with an access point through a wireless local area network (WLAN) over one or multiple wireless links, or can be an access point configured to establish a connection with one or more other wireless devices through a WLAN over one or multiple wireless links. In some embodiments, the wireless device can operate in each of the multiple wireless links using a respective radio of the one or more radios.

The wireless device can generate one or more media access control (MAC) protocol data units (MPDUs) and one or more control frames. The control frame(s) can include MAC header signaling information for the MPDU(s), packet number information for the control frame, and sequence number range information for the MPDU(s), all of which can be integrity protected. The control frame(s) can be aggregated with the MPDU(s) for transmission together in the same physical layer protocol data unit (PPDU), and/or can be transmitted in a separate PPDU, for example as part of initial control frame/initial control response signaling.

Use of such PPDU level integrity protection can leverage the possible design feature that all of the MPDUs in an aggregated MPDU (A-MPDU) will have the same MAC header signaling, such that signaling such information once (or relatively few times) per PPDU and in a protected manner can have a lower overhead and implementation complexity cost than providing such protection on a per-MPDU basis, while providing a similar protection level, at least according to some embodiments.

The techniques described herein can be implemented in and/or used with a number of different types of devices, including but not limited to cellular phones, tablet computers, accessory and/or wearable computing devices, portable media players, base stations, access points, and other network infrastructure equipment, servers, unmanned aerial vehicles, unmanned aerial controllers, automobiles and/or motorized vehicles, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including a wireless device, according to some embodiments;

FIG. 2 is a block diagram illustrating an example wireless device, according to some embodiments;

FIG. 3 is a block diagram illustrating an example network element or access point, according to some embodiments;

FIG. 4 is a block diagram illustrating an example modem or baseband processor, according to some embodiments;

FIG. 5 is a flowchart diagram illustrating an example method for providing control frame based integrity protection for media access control (MAC) header content in a wireless local area network, according to some embodiments;

FIG. 6 illustrates example aspects of possible data flow operation between a transmitter and a receiver, according to some embodiments;

FIG. 7 illustrates an example communication timeline in which 802.11me protected block acknowledgement capability can be used, according to some embodiments;

FIG. 8 illustrates an example communication flow in which protected MAC Headers and block acknowledgement can be used, according to some embodiments;

FIG. 9 is a table illustrating possible receiver operations based on packet number, MAC header, and payload integrity checks in the example scenario of FIG. 8, according to some embodiments;

FIG. 10 illustrates aspects of a possible example MAC protocol data unit (MPDU) format that includes protected MAC headers, according to some embodiments;

FIG. 11 illustrates aspects of an example aggregated MPDU (A-MPDU) that includes a protected control frame, according to some embodiments;

FIG. 12 illustrates example aspects of possible receiver operations when control frame-based MAC Header integrity protection is in use, according to some embodiments;

FIGS. 13-14 illustrate examples of possible MAC Header formats for a MAC Header that could be used when a protected control frame is aggregated to A-MPDU and for a MAC header protected at MPDU level, according to some embodiments;

FIGS. 15-16 illustrate example aspects of possible spacing/padding requirements for MPDU-level MAC header protection and physical layer protocol data unit (PPDU)-level MAC header protection approaches respectively, according to some embodiments;

FIGS. 17-20 illustrate various example fields and sub-fields that could be included in protected control frame signaling for multi-traffic identifier transmissions, according to some embodiments;

FIG. 21 illustrates an example set of frame exchanges that could occur during a transmit opportunity according to a PPDU-level MAC header protection framework, according to some embodiments;

FIG. 22 illustrates aspects of example scenarios for each of several possible approaches to PPDU-level MAC header protection for triggered access uplink operation, according to some embodiments;

FIGS. 23-26 illustrate aspects of possible MAC header format changes that could be used in conjunction with PPDU-level MAC header protection techniques, according to some embodiments;

FIG. 27 illustrates aspects of an example MAC header version that includes the Frame Control and Quality of Service Control field versions of FIGS. 25-26, according to some embodiments;

FIGS. 28-31 illustrate aspects of various possible MAC header format versions that could be used in various possible MAC header protection approaches, according to some embodiments;

FIG. 32 is a table indicating possible MAC Header length differences per MPDU among the various possible MAC Header formats of FIGS. 28-31, according to some embodiments;

FIG. 33 illustrates aspects of an example scenario for A-MPDU aggregation with aggregated MAC service data unit (A-MSDU), according to some embodiments;

FIG. 34 illustrates an example A-MSDU frame format that includes destination address and source address information, according to some embodiments;

FIG. 35 illustrates aspects of possible receiver reorder buffer handling in various circumstances, according to some embodiments; and

FIG. 36 illustrates aspects of a possible attack scenario with large sequence number that can be prevented using protected largest sequence number signaling, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Terminology

The following are definitions of terms used in this disclosure:

Memory Medium—Any of various types of non-transitory memory devices or storage devices. The term “memory medium” is intended to include any computer system memory or random access memory, such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), server-based computer system, wearable computer, network appliance, Internet appliance, smartphone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable, and that perform wireless communications. Examples of UE devices include mobile telephones or smart phones (e.g., iPhone™, Android™-based phones), tablet computers, portable gaming devices, laptops, wearable devices (e.g., smart watch, smart glasses, smart goggles, head-mounted display devices, and so forth), portable Internet devices, music players, data storage devices, or other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device or Station (STA)—any of various types of computer systems or devices that perform wireless communications. A wireless device can be portable (or mobile), or can be stationary or fixed at a certain location. The terms “station” and “STA” are used similarly. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station or Access Point (AP)—The term “Base Station” has the full breadth of its ordinary meaning, and at least includes a wireless communication station installed at a fixed location and used to communicate as part of a wireless communication system. The term “access point” (or “AP”) is typically associated with Wi-Fi-based communications and is used similarly.

Processing Element (or Processor)—refers to various elements or combinations of elements that are capable of performing a function in a device, e.g., in a communication device or in a network infrastructure device. Processors can include, for example: processors and associated memory, circuits such as an ASIC (Application Specific Integrated Circuit), portions or circuits of individual processor cores, entire processor cores, processor arrays, programmable hardware devices such as a field programmable gate array (FPGA), and/or larger portions of systems that include multiple processors, as well any of various combinations of the above.

IEEE 802.11—refers to technology based on IEEE 802.11 wireless standards such as 802.11a, 802.11b, 802.11g, 802.11n, 802.11-2012, 802.11ac, 802.11ad, 802.11ax, 802.1lay, 802.11be, and/or other IEEE 802.11 standards. IEEE 802.11 technology can also be referred to as “Wi-Fi” or “wireless local area network (WLAN)” technology.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

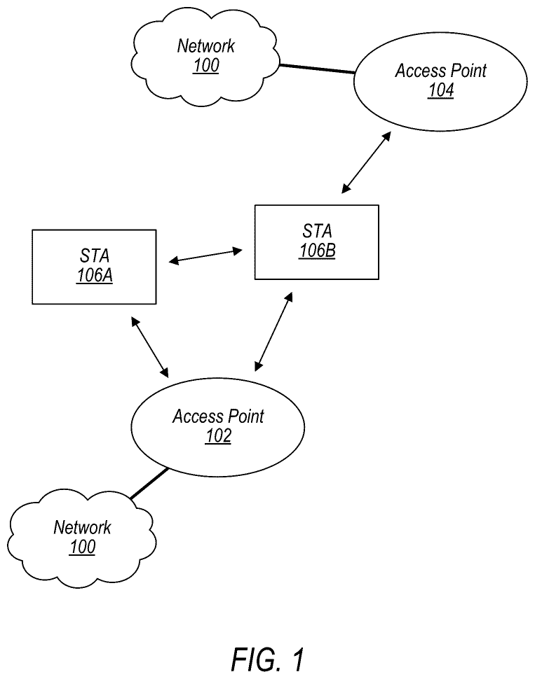

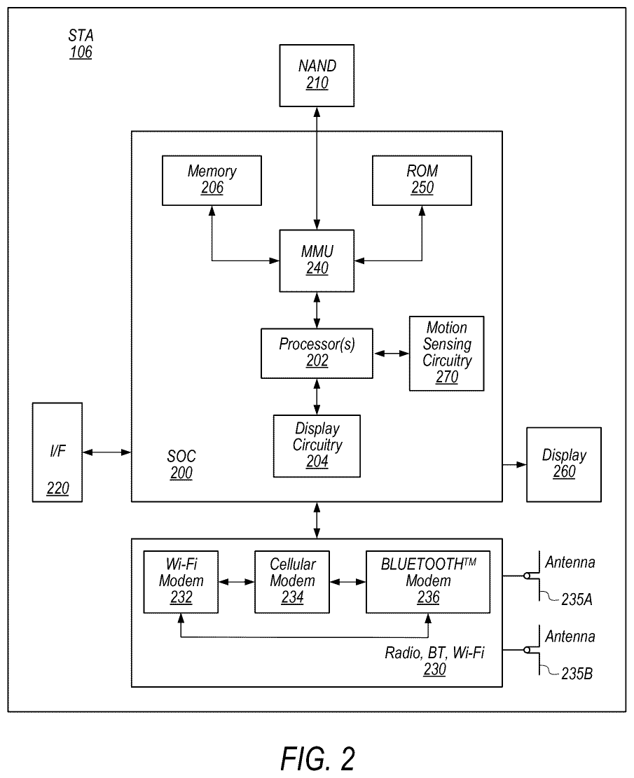

### FIGS. 1-2—Wireless Communication System

FIG. 1 illustrates an example of a wireless communication system. It is noted that FIG. 1 represents one possibility among many, and that features of the present disclosure can be implemented in any of various systems, as desired. For example, instances described herein can be implemented in any type of wireless device. The wireless communication system described below is one example.

As shown, the exemplary wireless communication system includes an access point (AP) 102, which communicates over a transmission medium with one or more wireless devices 106A, 106B, etc. Wireless devices 106A and 106B can be user devices, such as stations (STAs), non-AP STAs, UEs, or other WLAN devices.

The STA 106 can be a device with wireless network connectivity, such as a mobile phone, a hand-held device, a wearable device (e.g., such as a smart watch, smart glasses, and/or a head-mounted display device), a computer or a tablet, an unmanned aerial vehicle (UAV), an unmanned aerial controller (UAC), an automobile, or virtually any other type of wireless device. The STA 106 can include a processor (processing element) that is configured to execute program instructions stored in memory. The STA 106 can perform any of the methods described herein by executing one or more of such stored instructions. Alternatively, or in addition, the STA 106 can include a programmable hardware element, such as an FPGA (field-programmable gate array), an integrated circuit (e.g., an ASIC), a programmable logic device (PLD), and/or any of various other possible hardware components that are configured to perform (e.g., individually or in combination) any of the methods described herein, or any portion of any of the methods described herein.

The AP 102 can be a stand-alone AP or an enterprise AP, can be a base transceiver station (BTS) or cell site, and can include hardware that enables wireless communication with the STA devices 106A and 106B. The AP 102 can also be equipped to communicate with a network 100 (e.g., a core network of a service provider (e.g., a cellular service provider, an Internet service provider, and/or a carrier), a WLAN, an enterprise network, and/or another communication network connected to the Internet, among various possibilities). Thus, the AP 102 can facilitate communication among the STA devices 106 and/or between the STA devices 106 and the network 100. AP 102 can be configured to provide communications over one or more wireless technologies, such as any, any combination of, and/or all of 802.11 a, b, g, n, ac, ad, ax, ay, be and/or other 802.11 versions, and/or a cellular protocol, such as 6G, 5G and/or LTE, including in an unlicensed band.

The communication area (or coverage area) of the AP 102 can be referred to as a basic service arca (BSA) or cell. The AP 102 and the STAs 106 can be configured to communicate over the transmission medium using any of various radio access technologies (RATs) or wireless communication technologies, such as Wi-Fi, LTE, LTE-Advanced (LTE-A), 5G NR, 6G, ultra-wideband (UWB), etc.

AP 102 and other similar access points (not shown) operating according to one or more wireless communication technologies can thus be provided as a network, which can provide continuous or nearly continuous overlapping service to STA devices 106A-B and similar devices over a geographic area, e.g., via one or more communication technologies. A STA can roam from one AP to another AP directly, or can transition between APs and/or network cells (e.g., such as cellular network cells).

Note that at least in some instances a STA device 106 can be capable of communicating using any of multiple wireless communication technologies. For example, a STA device 106 might be configured to communicate using Wi-Fi, LTE, LTE-A, 5G NR, 6G, Bluetooth, UWB, one or more satellite systems, etc. Other combinations of wireless communication technologies (including more than two wireless communication technologies) are also possible. Likewise, in some instances a STA device 106 can be configured to communicate using only a single wireless communication technology.

As shown, the exemplary wireless communication system can also include an access point (AP) 104, which communicates over a transmission medium with the wireless device 106B. The AP 104 also provides communicative connectivity to the network 100. Thus, wireless devices can connect to either or both of AP 102 (or another cellular base station) and the access point 104 (or another access point) to access the network 100. For example, a STA can roam from AP 102 to AP 104, e.g., based on one or more factors, such as mobility, coverage, interference, and/or capabilities. Note that it can also be possible for the AP 104 to provide access to a different network (e.g., an enterprise Wi-Fi network, a home Wi-Fi network, etc.) than the network to which the AP 102 provides access.

The STAs 106A and 106B can include handheld devices such as smart phones or tablets, wearable devices such as smart watches, smart glasses, head-mountable display devices, and/or can include any of various types of devices with wireless communication capability. For example, one or more of the STAs 106A and/or 106B can be a wireless device intended for stationary or nomadic deployment, such as an appliance, measurement device/sensor, control device, etc.

The STA 106B can also be configured to communicate with the STA 106A. For example, the STA 106A and STA 106B can be capable of performing direct device-to-device (D2D) communication. Note that such direct communication between STAs can also or alternatively be referred to as peer-to-peer (P2P) communication. The direct communication can be supported by the AP 102 (e.g., the AP 102 can facilitate discovery, among various possible forms of assistance), or can be performed in a manner unsupported by the AP 102. Such P2P communication can be performed using 3GPP-based D2D communication techniques, Wi-Fi-based P2P communication techniques, UWB, BT, and/or any of various other direct communication techniques, according to various examples.

The STA 106 can include one or more devices or integrated circuits for facilitating wireless communication, potentially including a Wi-Fi modem, cellular modem, and/or one or more other wireless modems. The wireless modem(s) can include one or more processors (processor elements) and various hardware components as described herein. The STA 106 can perform any of (or any portion of) the methods described herein by executing instructions on one or more programmable processors. For example, the STA 106 can be configured to perform techniques for providing control frame based integrity protection for media access control header content in a wireless communication system, such as according to the various methods described herein. Alternatively, or in addition, the one or more processors can be one or more programmable hardware elements such as an FPGA (field-programmable gate array), application-specific integrated circuit (ASIC), or other circuitry, that is configured to perform any of the methods described herein, or any portion of any of the methods described herein. The wireless modem(s) described herein can be used in a STA device as defined herein, a wireless device as defined herein, or a communication device as defined herein. The wireless modem described herein can also be used in an AP, a base station, a pico cell, a femto cell, and/or other similar network side device.

The STA 106 can include one or more antennas for communicating using two or more wireless communication protocols or radio access technologies (RATs). In some instances, the STA device 106 can be configured to communicate using a single shared radio. The shared radio can couple to a single antenna, or can couple to multiple antennas (e.g., for MIMO) for performing wireless communications. Alternatively, the STA device 106 can include two or more radios, each of which can be configured to communicate via a respective wireless link. Other configurations are also possible.

### FIG. 2—Example Block Diagram of a STA Device

FIG. 2 illustrates an example block diagram of a STA device, such as STA 106. In some instances, the STA 106 can additionally or alternatively be referred to as a UE 106. STA 106 also can be referred to as a non-AP STA 106. As shown, the STA 106 can include a system on chip (SOC) 200, which can include one or more portions configured for various purposes. Some or all of the various illustrated components (and/or other device components not illustrated, e.g., in variations and alternative arrangements) can be “communicatively coupled” or “operatively coupled,” which terms can be taken herein to mean components that can communicate, directly or indirectly, when the device is in operation.

In some instances, the STA 106 can be configured as a Multi-Link Device (MLD). In such instances, the STA 106 (e.g., one or more radios of the STA 106) can be configured for concurrent data transmission and reception in multiple channels across a single band and/or multiple frequency bands (e.g., such as a 2.4 GHz band, a 5 GHz band, and/or a 6 GHz band). As such, the STA 106 (e.g., one or more radios of the STA 106) can be configured to perform Multi-Link Operation (MLO). For example, the STA 106 (e.g., one or more radios of the STA 106) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

As shown, the SOC 200 can include processor(s) 202, which can execute program instructions for the STA 106, and display circuitry 204, which can perform graphics processing and provide display signals to the display 260. The SOC 200 can also include motion sensing circuitry 270, which can detect motion of the STA 106 in one or more dimensions, for example using a gyroscope, accelerometer, and/or any of various other motion sensing components. The processor(s) 202 can also be coupled to memory management unit (MMU) 240, which can be configured to receive addresses from the processor(s) 202 and translate those addresses to locations in memory (e.g., memory 206, read only memory (ROM) 250, flash memory 210). The MMU 240 can be configured to perform memory protection and page table translation or set up. In some instances, the MMU 240 can be included as a portion of the processor(s) 202.

As shown, the SOC 200 can be coupled to various other circuits of the STA 106. For example, the STA 106 can include various types of memory (e.g., including NAND flash 210), a connector interface 220 (e.g., for coupling to a computer system, dock, charging station, etc.), the display 260, and wireless communication circuitry 230 (e.g., for LTE, LTE-A, 5G NR, 6G, Bluetooth, Wi-Fi, NFC, GPS, UWB, peer-to-peer (P2P), device-to-device (D2D), etc.).

The STA 106 can include at least one antenna, and in some instances can include multiple antennas, e.g., 235A and 235B, for performing wireless communication with access points, base stations, wireless stations, and/or other devices. For example, the STA 106 can use antennas 235A and 235B to perform the wireless communication. As noted above, the STA 106 can, in some examples, be configured to communicate wirelessly using a plurality of wireless communication standards or radio access technologies (RATs).

The wireless communication circuitry 230 can include a Wi-Fi modem 232, a cellular modem 234, and a Bluetooth modem 236. Note that one or more of the Wi-Fi modem 232, the cellular modem 234, and/or the Bluetooth modem 236 can be configured for MLO, e.g., as described above. The Wi-Fi modem 232 is for enabling the STA 106 to perform Wi-Fi or other WLAN communications, e.g., on an 802.11 network. The Bluetooth modem 236 is for enabling the STA 106 to perform Bluetooth communications. The cellular modem 234 can be capable of performing cellular communication according to one or more cellular communication technologies, e.g., in accordance with one or more 3GPP specifications.

As described herein, STA 106 can include hardware and software components for implementing aspects of this disclosure. For example, one or more components of the wireless communication circuitry 230 (e.g., Wi-Fi modem 232, cellular modem 234, BT modem 236) of the STA 106 can be configured to implement part or all of the methods for providing control frame based integrity protection for media access control header content described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

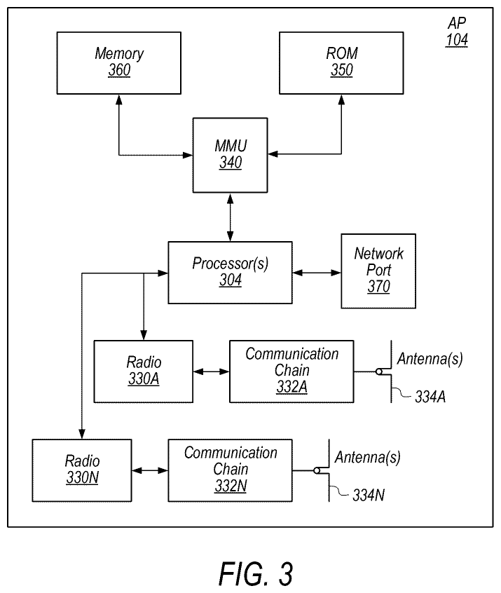

### FIG. 3—Block Diagram of an Access Point

FIG. 3 illustrates an example block diagram of an access point (AP) 104. In some instances (e.g., in an 802.11 communication context), the AP 104 can also be referred to as a station (STA), and possibly more particularly as an AP STA. It is noted that the AP of FIG. 3 is merely one example of a possible access point. As shown, AP 104 can include processor(s) 304, which can execute program instructions for the AP 104. The processor(s) 304 can also be coupled to memory management unit (MMU) 340, which can be configured to receive addresses from the processor(s) 304 and translate those addresses to locations in memory (e.g., memory 360 and read only memory (ROM) 350) or to other circuits or devices.

In some instances, the AP 104 can be configured as a Multi-Link Device (MLD). In such instances, the AP 104 (e.g., one or more radios of the AP 104) can be configured for concurrent data transmission and reception in multiple channels across a single band and/or multiple frequency bands (e.g., such as a 2.4 GHz band, a 5 GHz band, and/or a 6 GHz band). As such, the AP 104 (e.g., one or more radios of the AP 104) can be configured to perform Multi-Link Operation (MLO). For example, the AP 104 (e.g., one or more radios of the AP 104) can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The AP 104 can include at least one network port 370. The network port 370 can be configured to couple to a network and provide multiple devices, such as STA devices 106, with access to the network, for example as described herein above in FIG. 1.

The network port 370 (or an additional network port) can also or alternatively be configured to couple to a cellular network, e.g., a core network of a cellular service provider (e.g., a carrier and/or cellular carrier). The core network can provide mobility related services and/or other services to a plurality of devices, such as STA devices 106. In some cases, the network port 370 can couple to a telephone network via the core network, and/or the core network can provide a telephone network (e.g., among other STA devices serviced by the cellular service provider).

The AP 104 can include one or more radios 330A-330N, which can be coupled to one or more respective communication chains and at least one antenna 334, and possibly multiple antennas. The antenna(s) 334 can be configured to operate, in conjunction with one or more other components, as a wireless transceiver and can be further configured to communicate with STA devices 106 via radios 330A-330N. Note that one or more of the radios 330A-330N can be configured for MLO, e.g., as described above. The antenna(s) 334A-N communicate with one or more respective radios 330A-N via communication chains 332A-N. Communication chains 332 can be receive chains, transmit chains, or both. The radios 330A-N can be configured to communicate in accordance with various wireless communication standards, including, but not limited to, LTE, LTE-A, 5G NR, 6G, UWB, Wi-Fi, BT, etc. The AP 104 can be configured to operate on multiple wireless links using the one or more radios 330A-N. In some implementations, each radio can be used to operate on a respective wireless link.

The AP 104 can be configured to communicate wirelessly using multiple wireless communication standards. In some instances, the AP 104 can include multiple radios, which can enable the network entity to communicate according to multiple wireless communication technologies. For example, as one possibility, the AP 104 can include a 4G or 5G radio for performing communication according to a 3GPP wireless communication technology, as well as a Wi-Fi radio for performing communication according to one or more Wi-Fi specifications. In such a case, the AP 104 can be capable of operating as both a cellular base station and a Wi-Fi access point. As another possibility, the AP 104 can include a multi-mode radio that is capable of performing communications according to any of multiple wireless communication technologies (e.g., 5G NR and Wi-Fi, 5G NR and LTE, etc.). As still another possibility, the AP 104 can be configured to act exclusively as a Wi-Fi access point, e.g., without cellular communication capability.

As described further herein, the AP 104 can include hardware and software components for implementing or supporting implementation of features described herein, such as those for providing control frame based integrity protection for media access control header content, among various other possible features. The processor 304 of the AP 104 can be configured to implement, or support implementation of, part or all of the methods described herein, e.g., by executing program instructions stored on a memory medium (e.g., a non-transitory computer-readable memory medium) to operate multiple wireless links using multiple respective radios. Alternatively, the processor 304 can be configured as a programmable hardware element, such as an FPGA (Field Programmable Gate Array) or ASIC (Application Specific Integrated Circuit), or a combination thereof. Alternatively (or in addition) the processor 304 of the AP 104, in conjunction with one or more of the other components 330, 332, 334, 340, 350, 360, 370 can be configured to implement, or support implementation of, part or all of the features described herein.

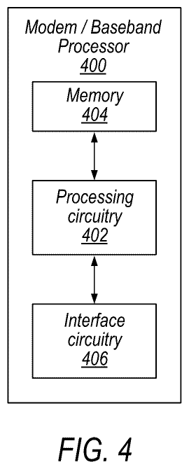

### FIG. 4—Block Diagram of a Modem or Baseband Processor

FIG. 4 illustrates an example block diagram of a modem 400, which can also be referred to as baseband processor 400. The modem 400 can provide signal processing functionality for one or more wireless communication technologies, such as Wi-Fi, Bluetooth, and/or a cellular (e.g., 3GPP) communication technology. Thus, as one possibility, modem 400 can represent a Wi-Fi modem; for example, the modem 400 illustrated in FIG. 4 can represent one possible example of Wi-Fi modem 232 illustrated in FIG. 2. As another possibility, modem 400 can represent a cellular modem or cellular baseband processor; for example, the modem 400 illustrated in FIG. 4 can represent one possible example of cellular modem 234 illustrated in FIG. 2. As a still further possibility, modem 400 can represent a Bluetooth modem; for example, the modem 400 illustrated in FIG. 4 can represent one possible example of Wi-Fi modem 236 illustrated in FIG. 2. In some instances, the modem 400 could implement functionality for supporting communication according to multiple wireless communication technologies. At least in some instances, the modem 400 can run a real-time operating system, e.g., for facilitating performance of timing-dependent wireless communication functionality.

In some instances, the modem 400 can be configured for concurrent data transmission and reception in multiple channels across a single band and/or multiple frequency bands (e.g., such as a 2.4 GHz band, a 5 GHz band, and/or a 6 GHz band). As such, the modem 400 can be configured to perform Multi-Link Operation (MLO). For example, the modem 400 can be configured to perform Simultaneous Transmit Receive (STR) operation (e.g., can be configured for simultaneous uplink and downlink traffic on a pair of links) and/or Enhanced Multi-Link Single-Radio (EMLSR) operation (e.g., can be configured such that a single-radio is used to listen to two or more links simultaneously).

The modem 400 can include processing circuitry 402, which could include one or more processor cores, ASICs, programmable hardware elements, digital signal processors, and/or other processing elements. The processing circuitry can be capable of preparing baseband signals for up-conversion and transmission by radio circuitry of a wireless device, and/or for processing baseband signals received and down-converted by radio circuitry of a wireless device. Such processing could include signal modulation, encoding, decoding, etc., among various possible functions. The processing circuitry can also or alternatively be capable of performing functionality for one or more baseband and/or other layers/sublayers of a protocol stack for the wireless communication technology (or technologies) implemented by the modem 400, such as physical layer (PHY) functionality, media access control (MAC) functionality, logical link control (LLC) functionality, radio resource control (RRC) functionality, radio link control (RLC) functionality, etc. In some instances, the modem 400 can itself include at least some radio circuitry (e.g., for performing the conversion of input baseband signals to radio frequency signals and/or of input radio frequency signals to baseband signals). Alternatively, or in addition, some or all such functions can be performed by separate radio/transceiver components of the wireless device.

The modem 400 can also include memory 404, which can include a non-transitory computer-readable memory medium. The memory 404 can include program instructions for performing signal processing and/or any of various possible general processing functions. The processing circuitry 402 can be capable of executing the program instructions stored in the memory 404. The memory 404 can also store data generated and/or used during processing performed by the processing circuitry 402.

As shown, the modem 400 can further include interface circuitry, e.g., for communicating with other components of a wireless device (such as STA 106 or AP 104 illustrated in FIGS. 1-3), such as an application processor, radio/transceiver circuitry, and/or any of various other components. Such interfaces can be implemented in any of various ways; for example, as one possibility, the modem 400 can have a direct interface with transceiver circuitry of a wireless device, and can have an additional indirect interface with an application processor and/or other components of the wireless device by way of a system bus. Other configurations are also possible.

In at least some instances, the hardware and software components of the modem 400 can be configured to implement or support implementation of features described herein, such as providing control frame based integrity protection for media access control header content, among various other possible features. For example, the processing circuitry 402 of the modem 400 can be configured to implement, or support implementation of, part or all of the methods described herein, e.g., by executing program instructions stored on memory (e.g., non-transitory computer-readable memory medium) 404 and/or using dedicated hardware components.

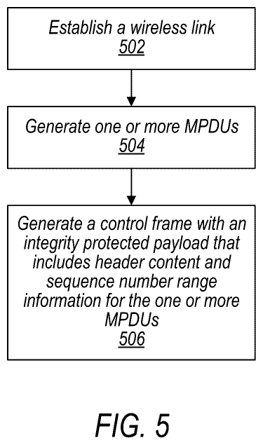

### FIG. 5—Control Frame Based Media Access Control Header Content Integrity Protection

FIG. 5 is a flowchart diagram illustrating a method for supporting providing control frame based integrity protection for media access control header content in a WLAN, according to some embodiments. In various embodiments, some of the elements of the methods shown can be performed concurrently, in a different order than shown, can be substituted for by one or more other method elements, or can be omitted. Additional method elements can also be performed as desired.

Aspects of the method of FIG. 5 can be implemented by a wireless device, such as the AP 104 or STA 106 illustrated in and described with respect to FIGS. 1-4, or more generally in conjunction with any of the computer circuitry, systems, devices, elements, or components shown in the Figures, among others, as desired. For example, a processor (such as baseband processor 400 illustrated in and described with respect to FIG. 4) and/or other hardware of such a device can be configured to cause the device to perform any combination of the illustrated method elements and/or other method elements.

Note that while at least some elements of the method of FIG. 5 are described in a manner relating to the use of communication techniques and/or features associated with IEEE 802.11 specification documents, such description is not intended to be limiting to the disclosure, and aspects of the method of FIG. 5 can be used in any suitable wireless communication system, as desired. As shown, the method can operate as follows.

At least two wireless devices may establish a wireless association (502). The wireless association may be established using Wi-Fi, wireless communication techniques that are based at least in part on Wi-Fi, and/or any of various other wireless communication technologies, according to various embodiments. For example, an access point (AP) wireless device may provide beacon transmissions including information for associating with the AP wireless device, and one or more other wireless devices (e.g., non-AP wireless devices) may request to associate with the AP wireless device using the information provided in the beacon transmissions, as one possibility. Variations and/or other techniques for establishing an association are also possible.

The AP wireless device may provide wireless local area network functionality to associated wireless devices, at least according to some embodiments. As part of the wireless local area network functionality, it may be possible for wireless devices to contend for medium access and perform wireless transmissions on one or more wireless communication channels (each of which could possibly include multiple sub-channels) according to general provisions of the wireless communication technology in use by the wireless local area network (e.g., Wi-Fi, as one possibility) and/or network specific parameters configured by the AP wireless device.

A wireless device may perform a data transmission to another wireless device with which it has formed an association. According to various embodiments, the data transmission can be initiated by the wireless device by contending for medium access (e.g., to avoid collisions and potential interference), or by receiving a transmit opportunity grant from another wireless device (e.g., the device with which it has formed an association) that has already contended for and obtained medium access, among other possibilities. Once medium access is obtained, the wireless device can transmit a physical layer (PHY) protocol data unit (PPDU) (which may also be referred to as a data frame) to the destination wireless device. The data frame can include physical layer signaling (e.g., including a preamble for frame detection, timing and frequency synchronization, channel estimation, etc., and header information indicating packet configuration, format, data rates, channel occupation time, and/or other control information) and data (which may in turn include one or more higher layer packets, such as media access control (MAC) protocol data units (MPDUs).

A wireless device may generate one or more MPDUs (504), which can include data received by the wireless device, such as data received from an upper (e.g., application) layer of the wireless device and intended to be provided to another device. Generating the MPDUs can include generating MAC headers for each MPDU.

The wireless device may generate a control frame associated with the one or more MPDUs. The control frame can include an integrity protected payload (e.g., the control frame can include a message integrity check field that can be used to confirm the integrity of the control frame), which can in turn include MAC header content and sequence number range information for the one or more MPDUs.

The MAC header content included in the control frame can include any or all of a more data (MD) field, a power management (PM) field, an end-of-service period (EOSP) field, a high throughput (HT) control field, and/or any of various other fields that are configured to provide MAC signaling information. Some or all such fields can also be included in the MAC headers of the one or more MPDUs, or can be omitted from the one or more MPDUs, or some can be included while others are omitted, according to various embodiments. In some embodiments, based on generation of the control frame associated with the one or more MPDUs, some or all of those MAC header fields of the MPDUs that are also included in the control frame can be set to reserved values when generating the one or more MPDUs. For example, some or all such fields could be included in the MPDU MAC headers to support backward compatibility with legacy wireless devices (e.g., for non-recipient legacy devices to be able to identify frame duration and perform power save operation accordingly), but may be ignored by the recipient wireless device and effectively superseded by the protected MAC header content included in the protected control frame.

The protected control frame can additionally or alternatively include sequence number range information for the one or more MPDUs. The sequence number range information can include information configured to prevent fake/tampered MPDUs with large sequence numbers from negatively impacting receiver reorder buffer operation. For example, the sequence number range information could include an indication of the largest sequence number for the one or more MPDUs. In case the one or more MPDUs include multiple traffic identifiers, the sequence number range information could include an indication of the largest sequence number for each TID for the one or more MPDUs.

In some embodiments, the sequence number range information may limit the number of MPDUs that the receiver may receive from the transmitter. The limited number of frames can help the receiver to allocate memory for the received frames and prepare for frame reception. For instance, the receiver can determine that received MPDUs will fit within the reorder buffer and that the STA can receive all frames.

In some embodiments, it can be possible that one or more new MPDU formats, e.g., including one or more new MAC Header versions, can be used in conjunction with control frame-based MAC signaling techniques. For example, in some embodiments, the one or more MPDUs can be generated according to a format version that includes a one octet frame control field and a one octet Quality of Service (QOS) control field at frame start and a duration field two octets after frame start. It can be possible that legacy devices can still obtain the duration information with such a format, e.g., based on the location of the duration field remaining where the legacy devices expect to find that field, and reduction of the frame control and Quality of Service field lengths to one octet can be possible based at least in part on provision of protected MAC header content in a protected control frame. As another possibility, the one or more MPDUs can be generated according to a format version that includes address 1 and address 2 indications for identifying a transmitter and a receiver for the one or more MPDUs in MAC headers of the one or more MPDUs and address 3 and address 4 indications for identifying network end points in aggregated MAC service data unit (A-MSDU) headers for the one or more MPDUs, or that omits address 3 and address 4 indications altogether, e.g., if such indications are not needed. According to yet another possible approach, the protected control frame can include address indications for identifying a transmitter and a receiver for the one or more MPDUs, and the one or more MPDUs can be generated according to a format version that does not include address indications for identifying a transmitter and a receiver for the one or more MPDUs.

The control frame and the associated one or more MPDUs can be transmitted by the wireless device. The transmission can be together, in some embodiments. For example, the control frame and the one or more MPDUs can be transmitted as an aggregated MPDU (A-MPDU) in one PPDU. As another possibility, the control frame and the one or more MPDUs can be transmitted separately. For example, the control frame can be an initial control frame (ICF) (e.g., multi-user request-to-send (MU-RTS) or other ICF) or initial control response (ICR) (e.g., clear-to-send (CTS) or other ICR), which can be transmitted as one PPDU, while the one or more MPDUs can be separately transmitted in an A-MPDU as a second PPDU.

Note that it can also be possible that multiple protected control frames are included in an A-MPDU, and/or that control frame-based integrity protection for MAC header content and/or MPDU sequence numbers be provided in ICF/ICR signaling as well as within an A-MPDU. For example, multiple identical protected control frames could be used for additional robustness. As another possibility, a second protected control frame could be generated and included later in an A-MPDU to provide an updated largest sequence number indication for the A-MPDU, e.g., based on data that arrived at the wireless device baseband after generation of a first protected control frame. That later-arriving data can be included in one or more additional MPDUs (e.g., with sequence numbers up to the updated largest sequence number indicated) that can also be aggregated to the A-MPDU and transmitted in the same PPDU, e.g., provided sufficient transmission resources are available for the additional MPDUs to also be included in the same A-MPDU/PPDU transmission. Similarly, it can be possible for a first protected control frame with a first largest sequence number indication to be provided in an ICF/ICR (e.g., that initiates a transmit opportunity), and for a second protected control frame with a second (e.g., updated) largest sequence number indication to be aggregated in an A-MPDU that also includes one or more MPDUs (e.g., during the transmit opportunity) and transmitted in a different PPDU.

Thus, according to the method of FIG. 5, it can be possible to provide MAC header signaling, sequence number, and transmitter protection based on protected control frames, such as in ICF/ICR signaling or aggregated protected control frames at A-MPDU or PPDU level. Such operation can accomplish the protection with reduced transmission overhead, reduced number of integrity calculations, and low-level hardware implementation work, among various other possible benefits, e.g., in comparison to providing such protection at MPDU level, at least according to some embodiments.

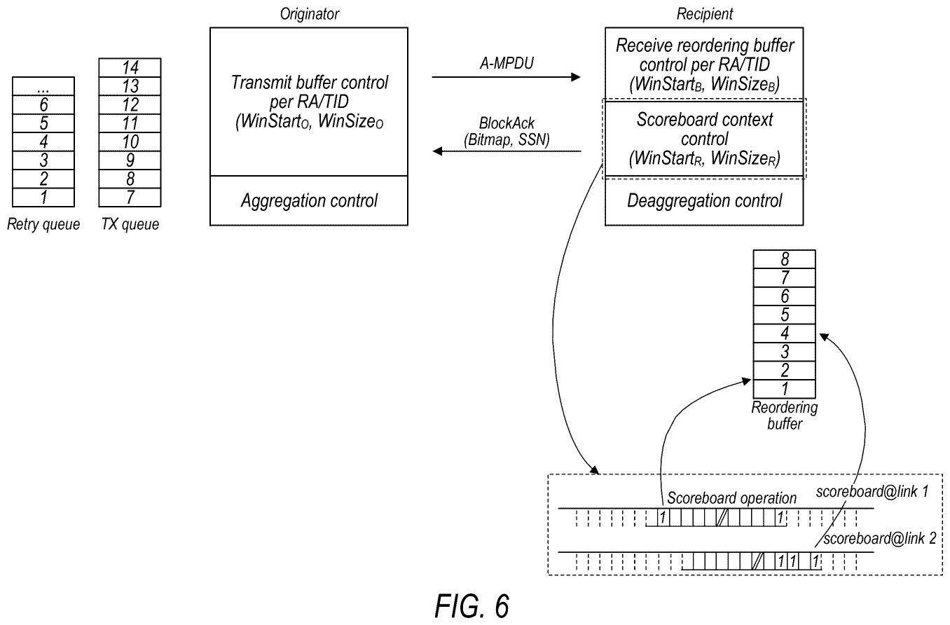

### FIGS. 6-36 and Additional Information

FIGS. 6-36 illustrate further aspects that might be used in conjunction with the method of FIG. 5. It should be noted, however, that the exemplary details illustrated in, and described with respect to, FIGS. 6-36 are not intended to be limiting to the disclosure as a whole: numerous variations and alternatives to the details provided herein below are possible and should be considered within the scope of the disclosure.

As described herein, Media Access Control (MAC) Header protection can be used to protect MAC header signaling (e.g., power management (PM), more data (MD), end of service period (EOSP), HT-Control fields), sequence number (SN) and packet number (PN) of transmitted frames. This can help protect MAC states, such as power save mode, operating mode indication, buffer status, etc., and can help maintain data transmission synchronization between the transmitter and the receiver, which can help reduce or avoid missed frames and/or transmission delays. There may be multiple possible ways of providing such protection.

FIG. 6 illustrates example aspects of possible data flow operation between a transmitter and a receiver, according to some embodiments. In the illustrated example, the transmitter can control the SN of the transmitted frame. The transmitter can (re) transmit frames so that they can be included in the reorder buffer at the receiver. The reordering buffer can be used to organize the received frames into sequence number order. If the transmitter does not transmit a frame such that it is missing from the reorder buffer, it can be the case that all frames in the reorder buffer are stored until the missing frame is received, or until the transmitter sends a block acknowledgement request (BAR) frame to move the block acknowledgement (BA) window forward. One possible benefit of MAC Header and BA protection can be to prevent an attacker from causing holes in a reorder buffer; this protection can prevent the transmitter from considering fake BAs that could otherwise cause frames to be removed from the transmission buffer, and/or the receiver can validate the received frames and send a BA based on real transmitted data frames. In some instances, the MAC Header and BA protection may still be imperfect, e.g., as it may be the case that the payload is not verified before BA transmission.

Some systems may provide encrypted MAC protocol data unit (MPDU) payload but no MAC Header or BA frame protection. This can leave the MAC Header signaling (PM, HT control) unprotected, such that an attacker may be able to send incorrect data frames and BA frames, which can confuse receiver SN maintenance. An alternative defined in IEEE 802.11me can include a Protected BA (PBAC), which can help protect BAR frame starting SN handling. It may be the case that the BAR frame does not move the BA bitmap forward; the data frames will move the BA bitmap and the BA may not be protected; this lack of BA and MAC header signaling (PM, A-Control field, etc.) protection can mean this approach can also potentially be vulnerable to attacks. A further alternative can include providing integrity protection for the MAC Headers and BA frames. To provide such protection, it can be the case that additional fields are added to MAC Headers, BA, and BAR control frames, with relatively few changes to legacy data flow but some additional overhead in each MPDU.

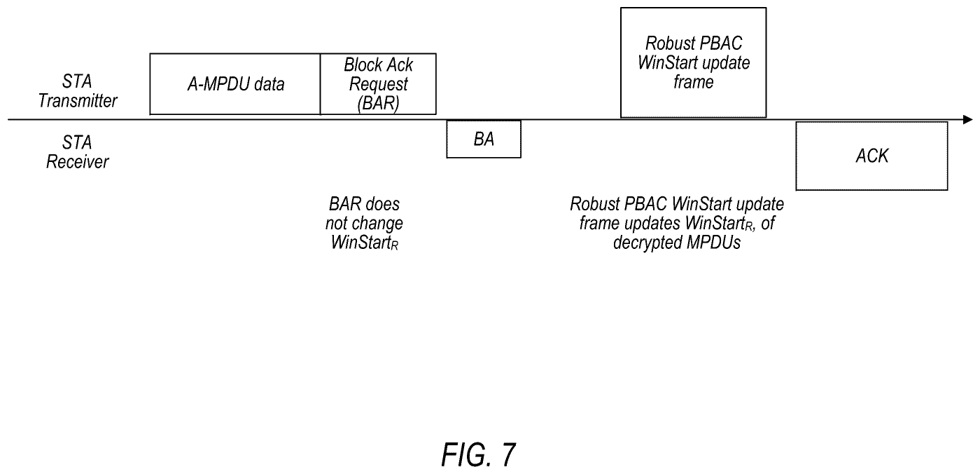

FIG. 7 illustrates an example communication timeline in which 802.11me PBAC can be used, according to some embodiments. The protected BA capability can be signaled in association, e.g., by setting the PBAC field to 1 in Extended RSN Capabilities. Protected BA can then be setup if both multi-link devices in the association support protected BA. It may be the case that the Protected Block Ack feature does not allow WinStartR update with BAR, multi-user-BAR (MU-BAR) or GroupCast with Retries (GCR) MU-BAR frames. An encrypted PBAC WinStart Update frame can update receiver SN. BAR frame can request BA based on the received frames. The received MPDUs can be decrypted before moving them to the reorder buffer; it can be the case that only the decrypted MPDUs may update receiver SN.

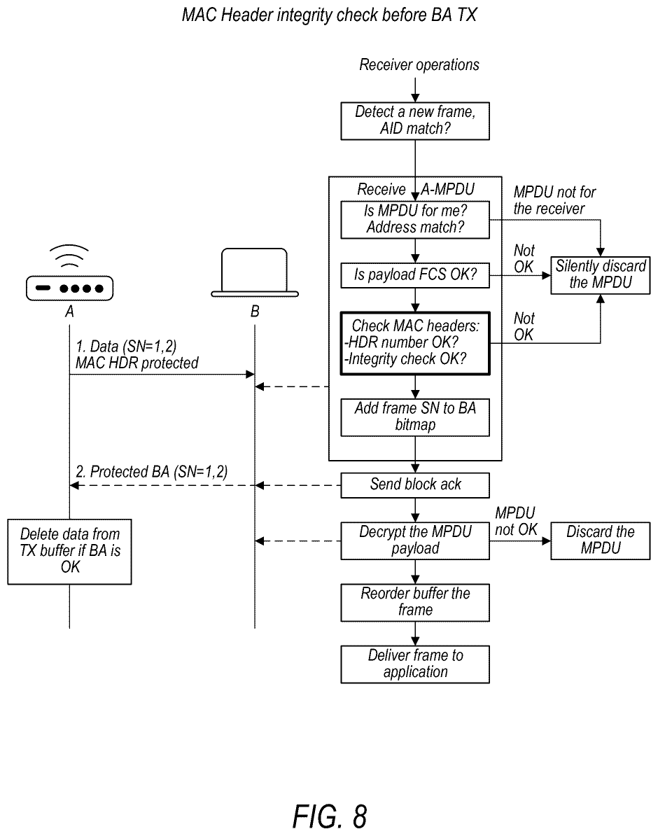

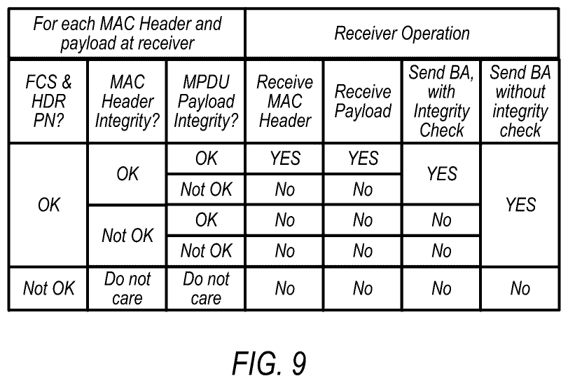

FIG. 8 illustrates an example communication flow in which protected MAC Headers and BA can be used, according to some embodiments. Inclusion of a MAC Header integrity check before the BA transmission can be used by the receiver to verify that transmitted frames are truly from the indicated transmitter. The BA can be transmitted based on the verified MAC Header sequence number. The receiver decrypts and integrity checks the MPDU payload after the BA is transmitted, in the illustrated example. An MPDU can be silently discarded if the payload integrity check fails, such that there may be no indication to the transmitter. The received BA can remove the MPDUs from the transmit buffer, such that there will not be retransmission of the MPDU payload in this case. FIG. 9 is a table illustrating possible receiver operations based on packet number, MAC header, and payload integrity checks in the example scenario of FIG. 8, according to some embodiments.

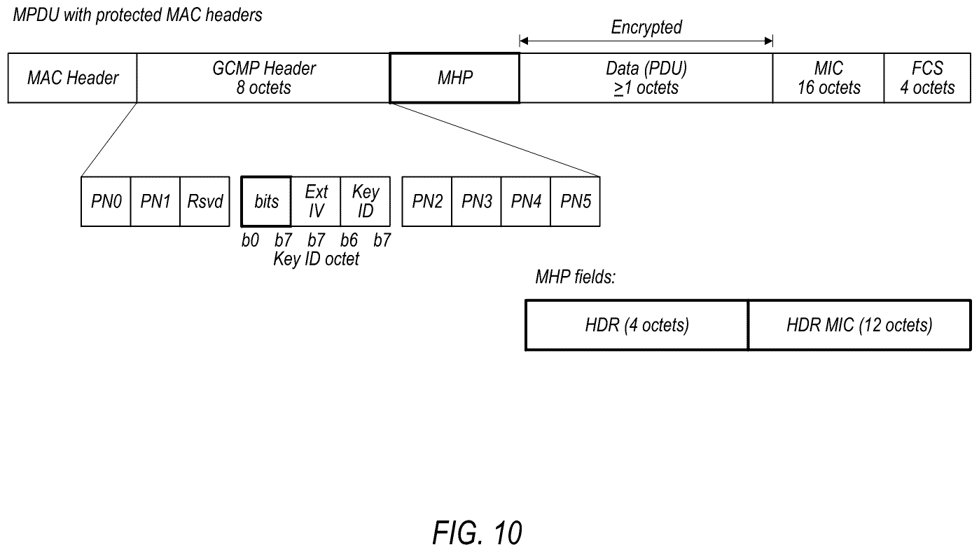

FIG. 10 illustrates aspects of a possible example MPDU format that includes protected MAC headers, according to some embodiments. As shown, in the illustrated example, MAC Header Protection (MHP) fields can include a 4 octet high data rate (HDR) packet number (PN) field and a 12 octet HDR message integrity check (MIC) field. Thus, the MAC Header protection can potentially add 16 octets per transmitted MPDU, which could represent approximately 1% additional overhead for MPDU size of 1500 octets. BA protection can similarly add approximately 20 octets per BA, at least as one possibility. Note that these values are provided by way of example only, and that other MAC Header protection and BA protection overhead values are also possible, as are numerous other MPDU sizes, in various scenarios.

The MAC Header integrity protection can enable transmitter verification, in some embodiments. For example, it can be the case that the HDR MIC may only be calculated by the true transmitter and receiver. The HDR PN can potentially prevent replay attacks with frames with HDR PN values smaller than the received HDR PN. MAC Header integrity protection can also enable a receiver to verify that the MAC header is not modified; for example, it can be the case that the HDR MIC integrity check fails if the MAC Header is modified. Note that it can be the case that the HDR MIC does not protect the MPDU payload, which can have a separate MIC. It can be the case that due to payload verification time, MPDU payload verification is possible only after BA transmission, in some embodiments.

Such a design for protecting MAC headers can potentially have a relatively high overhead cost in terms of transmitted frame size, and can also potentially have a higher implementation complexity and/or processing cost, for example as an AP may need to integrity check each MPDU's MAC Headers before sending a BA, at least in some embodiments. Accordingly, developing an alternative approach to providing MAC header protection with lower overhead, implementation complexity, and/or processing cost may potentially be advantageous.

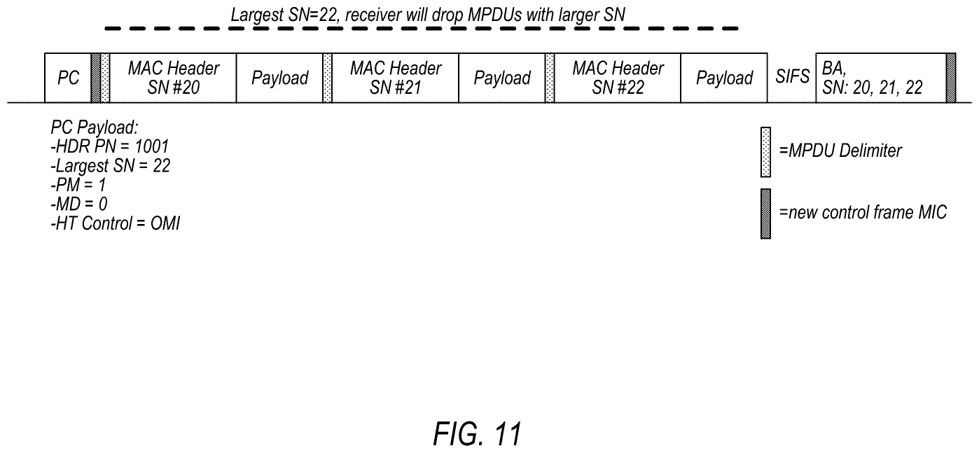

One such possible technique could include supporting use of PPDU-level protected control frames. For example, since all aggregated MPDUs in an A-MPDU can have the same value(s) in MAC Header signaling fields, it can be the case that a receiver needs to receive these MAC header signaling fields only once per PPDU. FIG. 11 illustrates aspects of an example aggregated MPDU (A-MPDU) that includes such a protected control frame, according to some embodiments. As shown, the protected control (PC) frame can be aggregated to the A-MPDU, and can include its own control frame MIC field to provide integrity protection to certain MAC Header information for the MPDUs of the A-MPDU that can be included in the PC frame. The receiver can thus integrity check the PC frame and respond only if a valid PC frame is received. The control frame HDR PN can be used by the receiver to detect and drop replayed PC frames. The PC frame can be a BAR, MU BAR, or trigger frame, according to various embodiments.

In some instances, the PC frame can signal the MAC Header fields More Data, PM, EOSP, and HT Control in the integrity protected payload of the PC frame. It may be the case that a HT-Control field is then not needed in the MAC Headers of the MPDUs, and/or the receiver may be able to ignore this content of the MAC headers in the MPDUs when a PC frame is transmitted. The PC frame can be aggregated to an A-MPDU together with data MPDUs: the trigger frame aggregation rules can be applied for the PC. The PC can be the first frame of the A-MPDU and it can be possible that additional exact copies of the PC can be included to the A-MPDU. In some instances, the PC can signal the SN range (the largest transmitted SN) of the A-MPDU. This can provide protection against attacks to move the receiver SN window, e.g., as the receiver can drop received MPDUs with larger SN value than the protected indication of the largest SN in the A-MPDU.

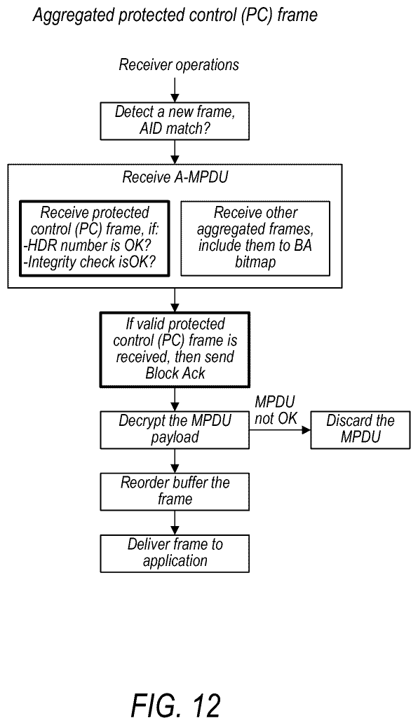

FIG. 12 illustrates example aspects of possible receiver operations when such a technique is in use for providing MAC Header integrity protection, according to some embodiments. As shown, when a new frame is detected with an AID match, the receiver can receive the A-MPDU, including receiving the PC frame and checking if the HDR number is OK and the integrity check is OK. If so, the other aggregated frames can be received and included to the BA bitmap, and a BA can be sent. The MPDU payload(s) can be decrypted, and discarded if not OK, or otherwise added to the reorder buffer and eventually delivered to the application. In this example scenario, the PC frame may need to be received and integrity checked only once, whereas MAC header protection in each MPDU may need to be separately checked per each received MPDU. Multiple PC copies can still be included to improve A-MPDU reception reliability, if desired. The largest transmitted SN signaling can potentially prevent attacks with too large SN value: the attacker may not be able to move the receiver BA window forward by sending fake MPDUs.

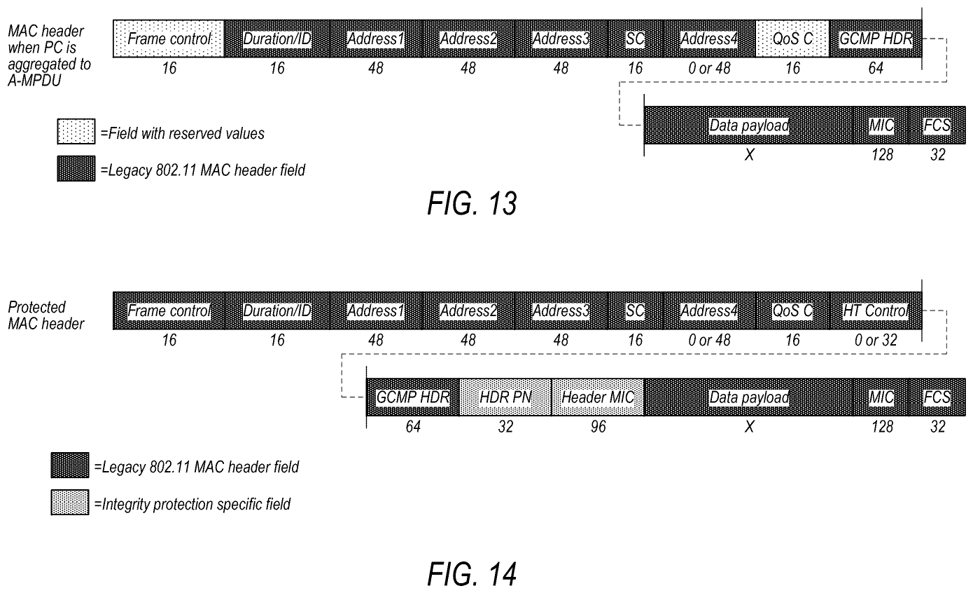

FIGS. 13-14 illustrate examples of possible MAC Header formats for a MAC Header that could be used when a PC is aggregated to an A-MPDU and for a MAC header protected at MPDU level, according to some embodiments. As shown, when a PC is aggregated to an A-MPDU, the PM, EOSP, MD fields of the MAC headers can be set to reserved value, or alternatively, the receiver can ignore these values from received MPDUs. In comparison, a protected MAC header not only includes those fields, but also includes integrity protection specific HDR PN and Header MIC fields, in the illustrated example.

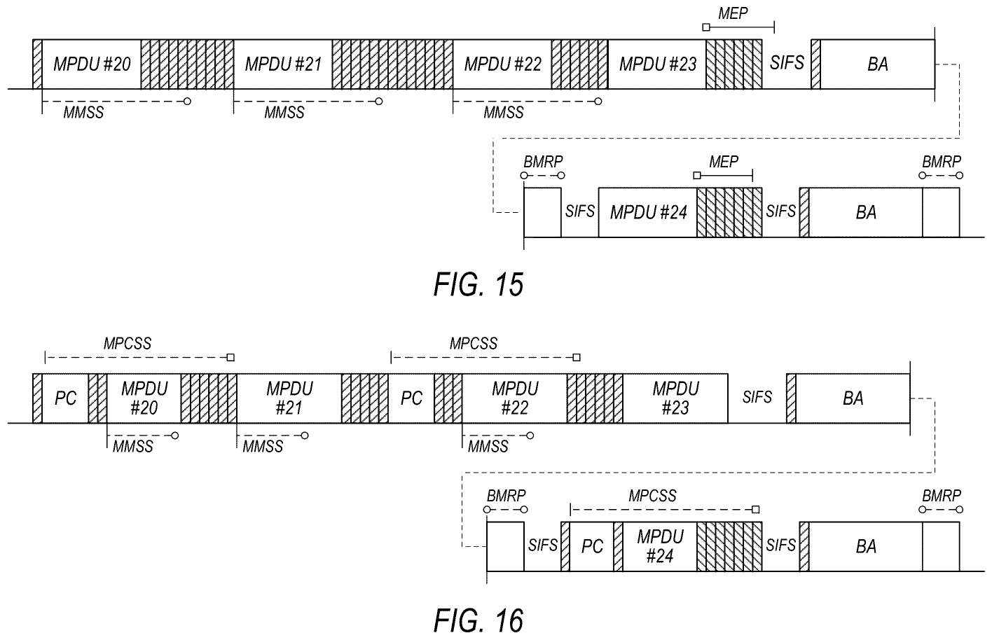

FIGS. 15-16 illustrate example aspects of possible spacing/padding requirements for protected MAC header and protected control frame approaches respectively, according to some embodiments. As shown, the minimum MPDU start spacing (MMSS) for a protected MAC header approach can be longer than for a protected control frame approach, as it can contain A-MPDU handling and MAC header integrity verification delays, while in the protected control frame approach it may be the case that it contains only MPDU de-aggregation delays. The minimum PC start spacing (MPCSS) may be the delay needed before the next copy of the protected control frame (Trigger or BAR) in an A-MPDU or before the next physical layer protocol data unit (PPDU), such as a BA or data PPDU. If only one or a few protected control frames are included in an A-MPDU, it may commonly be the case that no additional padding is needed to accommodate this spacing requirement for either approach, at least in some embodiments. The minimum end-of-frame padding (MEP) may need to be set to a value sufficient to complete MAC headers integrity verification in a protected MAC header approach, in some embodiments, while not being present in a protected control frame approach. The BA minimum receive padding (BMRP) may be set to a value needed to integrity check the BA frame; at least in the illustrated examples, there may be no difference between these protection alternatives for this aspect.

Thus, for the protected MAC headers used in the illustrated example of FIG. 15, padding may be needed after each MPDU, to avoid providing data, management or control frame transmissions during the MMSS, and implementation efficiency can potentially be highly sensitive to integrity verification time. In contrast, for the protected control frame used in the illustrated example of FIG. 16, padding may be needed only if a PC is provided at the end of an A-MPDU; data or management frames can be transmitted during MPCSS; and implementation efficiency can potentially be less sensitive to integrity verification time than in the protected MAC headers-based approach of the illustrated example of FIG. 15.

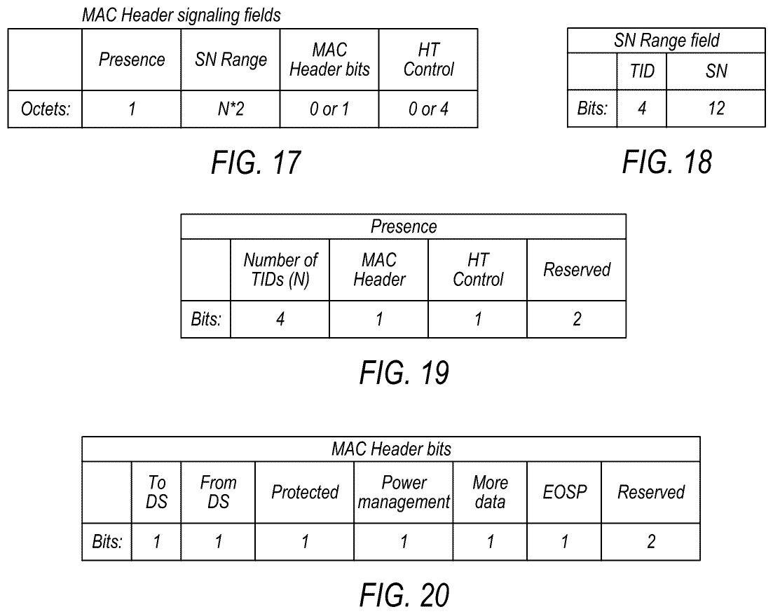

In some embodiments, it may be possible to transmit frames from multiple TIDs in the same A-MPDU. In such scenarios, it may be the case that each TID transmits one or more MPDUs, and each TID has a separate SN and Block Ack Window. The PC can contain the SN range field to signal the number of transmitted TIDs and TID specific largest SN transmission for each transmitted TID, and can include MAC header fields and HT control, if present. FIGS. 17-20 illustrate various example fields and sub-fields that could be included in such PC signaling for providing MAC header protection for multi-TID transmissions, according to some embodiments. As shown, the presence field can indicate the number of TIDs, and a SN range field for each TID can provide SN range information for each TID, while the MAC header bits can be used to provide the protected MAC header information.

In some embodiments, initial control frame (ICF) and initial control response (ICR) signaling can optionally be used to signal the SN range that may be transmitted in a TXOP. Such signaling can be transmitted in robust rates, such that the signaling can have a high likelihood of being received, at least in some embodiments. The ICF can define the largest SN of the TXOP initiator, while the ICR can define the largest SN of the TXOP receiver, for example. This SN can enable TXOP sharing or triggering within this SN space. The ICF-ICR can also contain protected MAC Header bits (e.g., PM, EOSP, MD, HT-Control), e.g., instead of or in addition to these bits being carried in the first transmitted PPDU from the transmitter after the ICF-ICR transmissions. The ICF-ICR signaling can set up the basic limit of SNs allowed in the TXOP, but it can also be possible that the transmitted A-MPDUs can contain PC frames that update the largest SN value and signal protected MAC Header bits. For example, such PC frames could be used to update the largest SN value and protected MAC Header bits due to new data arriving at the TXOP initiator or the TXOP receiver. In some instances, if an ICF-ICR exchange is performed in the initiation of the TXOP, PC transmission/reception is not mandatory for BA transmission, e.g., since the ICF-ICR exchange can provide the protected control function. Thus, the BA can be transmitted in such a scenario if received MPDUs in the TXOP fit within the largest SN value, in some embodiments. The BA can signal whether a PC is received from the acknowledged A-MPDU. If a PC is not received, then the A-MPDU does not update the existing protected MAC header bits, while if a PC is received, then the information that is present in the PC can be used to update the largest SN value and/or protected MAC header bits.

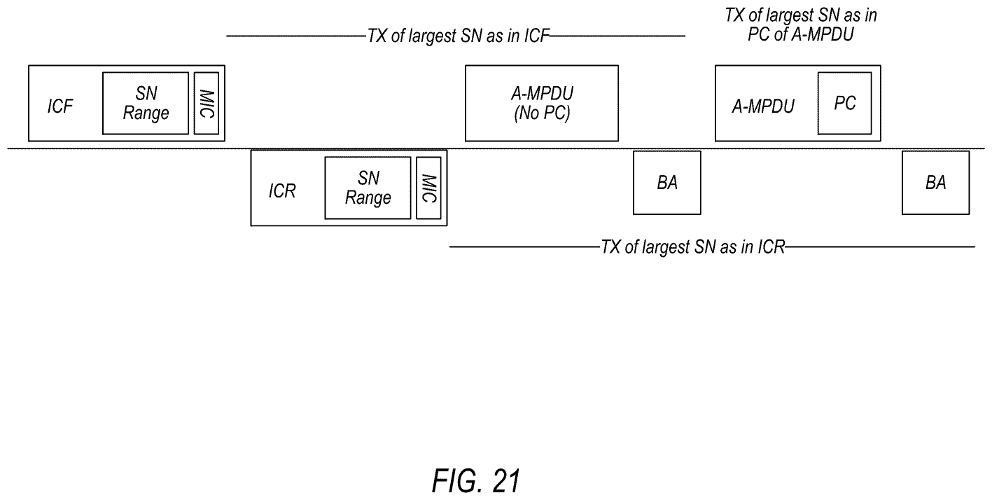

FIG. 21 illustrates an example set of frame exchanges that could occur during a TXOP according to such a framework, according to some embodiments. As shown, in the illustrated scenario, an ICF-ICR exchange may be used to provide SN range (and possibly other protected MAC header bits). A first A-MPDU and BA exchange follows in which no PC is included with the A-MPDU, and the largest SN of the transmission may be in accord with the largest SN as indicated in the ICF. In a second A-MPDU and BA exchange of the TXOP, a new PC included can indicate a new largest SN, which can potentially be larger than the previously signaled largest SN, e.g., to accommodate transmission of additional data that arrived after the ICF-ICR exchange, at least as one possibility.

Similar techniques can also be used for triggered access uplink operation, according to some embodiments. In triggered access, the AP can define the reservation unit (RU) for each triggered STA. The RU can have an associated BA and duration. The STA can signal the amount of traffic it has to transmit to help the AP to allocate the RU more precisely. A triggered STA can get new UL traffic when the triggered transmission time is ongoing, however. In some instances, the STA could have a sufficiently long UL RU allocation that it may be possible to transmit the new traffic during the RU. The largest SN protection could, in this scenario, potentially prevent transmission of such a newly arrived frame, e.g., because the availability of the data was not known when the PC was transmitted and thus not accounted for in the largest SN indicated. To avoid this, it can be possible that the largest SN field is not used in triggered transmissions; in this case, the PC can be added just to ensure the availability of the correct receiver, for example. If desired, the trigger frame HDR PN can be added to the PC value to ensure that the response is transmitted to the trigger frame. An A-MPDU can alternatively be allowed to carry a second PC that updates the largest SN in the TXOP. This second PC could, for example, be transmitted in cases in which more data becomes available for the triggered transmissions.

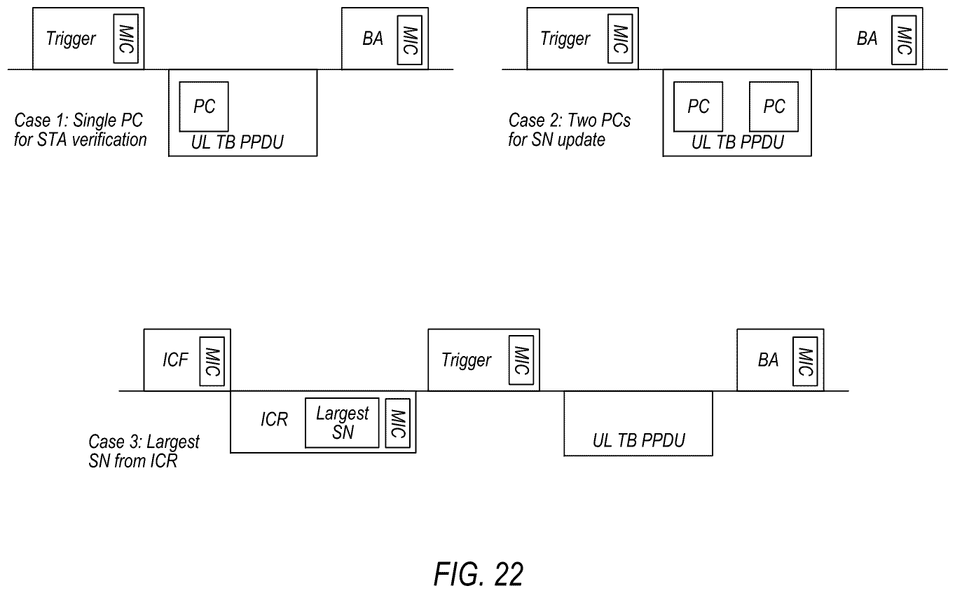

FIG. 22 illustrates aspects of example scenarios for each of these possible approaches, according to some embodiments. As shown, in the first illustrated scenario, a single PC can be included for STA verification. In the second illustrated scenario, multiple PCs can be used, such that a second PC can be used to update the largest SN for the UL TB PPDU. In the third illustrated scenario, the largest SN can be indicated in the ICR, e.g., prior to provision of the trigger frame for the UL TB PPDU.

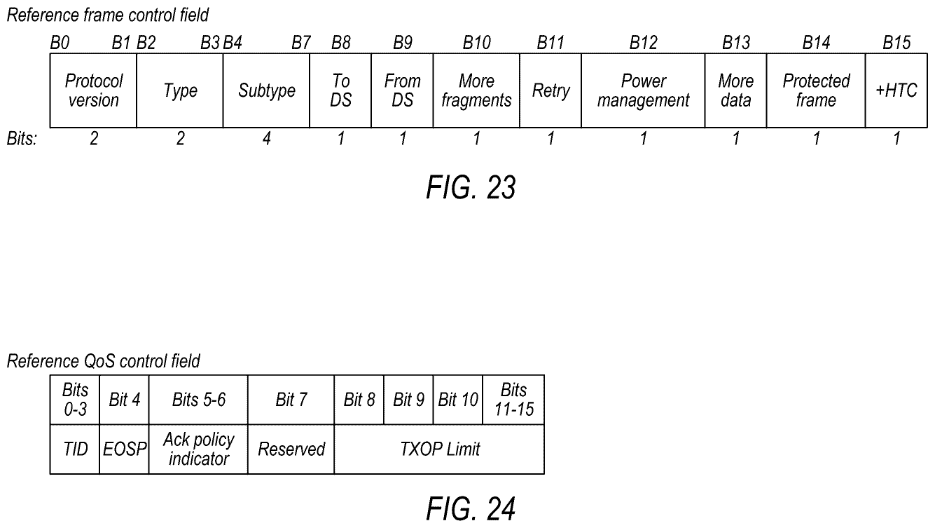

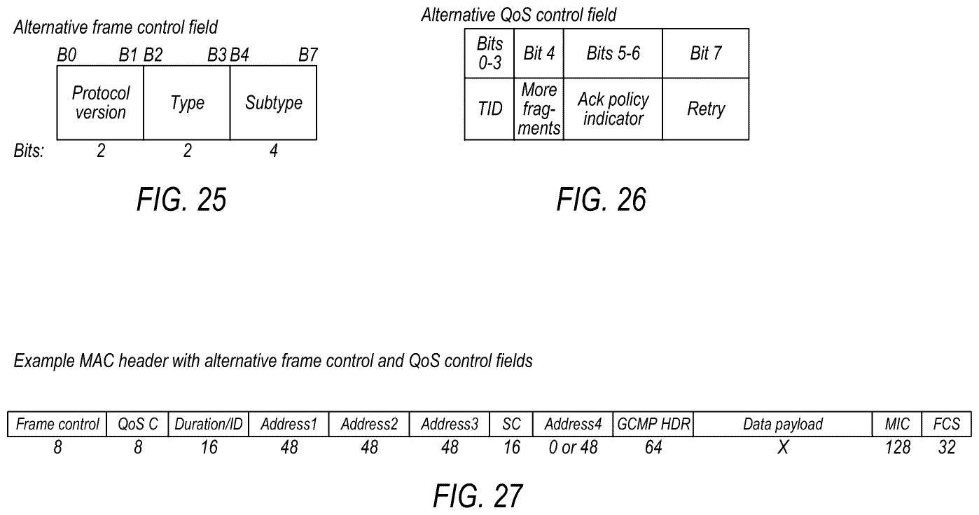

Protected control frame and ICF-ICR signaling can potentially allow for modifications to the MAC Header payload to be made, e.g., to potentially support more efficient signaling. FIGS. 23-26 illustrate aspects of these possible changes, according to some embodiments; in particular, where FIGS. 23-24 illustrate one set of possible Frame Control field and QoS Control field formats (e.g., reference formats), FIGS. 25-26 illustrate possible alternative Frame Control and QoS Control field formats. If a PC is configured for individually addressed frames, then some or all of the illustrated changes could be made to the corresponding MAC headers. The changes can include setting a protocol version to a value (e.g., 3, as one possibility) configured to signal a new MAC header format. The Frame Control field can be shortened to 1 octet; ToDS, FromDS, PM, MD, and +HTC fields can be carried in the PC, as these fields can be the same for all MPDUs in an A-MPDU, at least in some instances. Protected Frame and Retry fields can be moved to bits 4 and 7 of the QoS control field. The More Fragments field can be moved to GCR Headers. These changes can potentially keep the duration field position 2 octets from the frame start, which may enable legacy STAs to setup NAV for the transmission. FIG. 27 illustrates aspects of an example MAC header version that includes the Frame Control and QoS Control field versions of FIGS. 25-26, according to some embodiments.

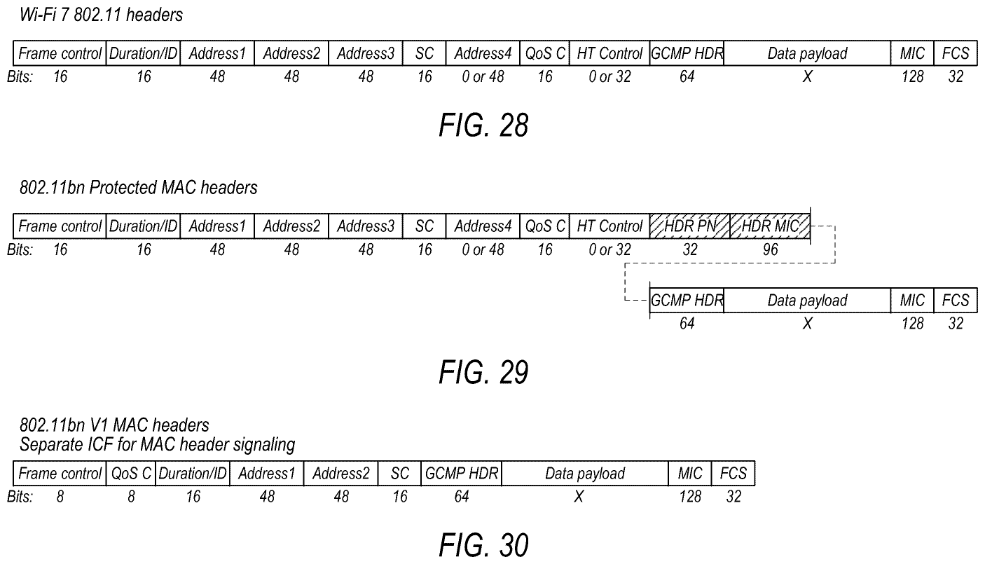

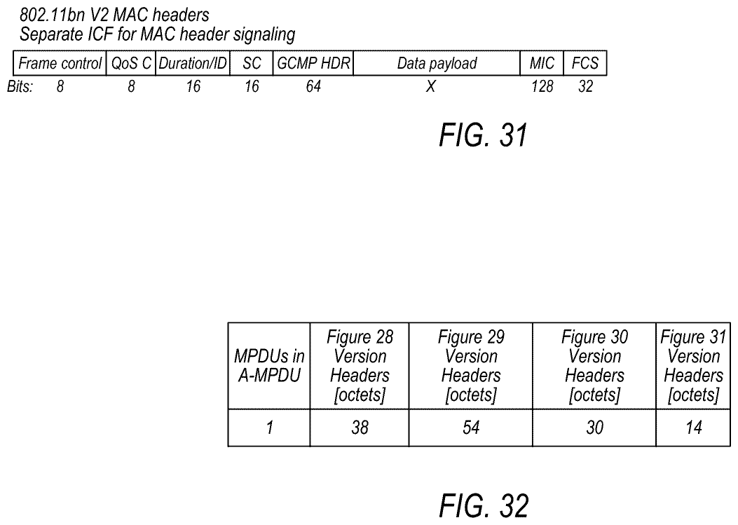

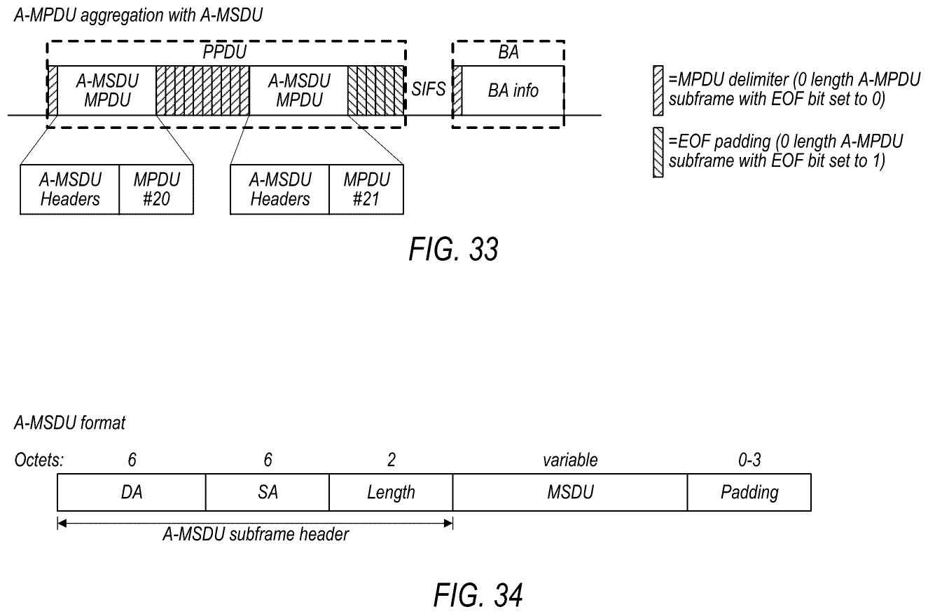

One or more further possible modifications could relate to address fields of MPDU MAC headers. FIG. 28 illustrates possible Wi-Fi 7 MAC Headers, while FIG. 29 illustrates possible Wi-Fi 8 MAC headers with MAC Header protection, according to some embodiments. As shown, up to 4 addresses can potentially be contained in these MPDU MAC headers. It can be the case that Address 1 and 2 are needed to identify the transmitter and receiver. Address 3 and 4 can be needed to identify the end points in the network. In some embodiments, it can be possible that the presence (or absence) of Address 3 and 4 can be configured; in such scenarios, if the Address 3 and 4 are present, they can be carried in A-MSDU headers. The A-MSDU headers can be encrypted with the data encryption and added before the payload. The A-MSDU present field can signal whether the MPDU contains A-MSDU headers. If A-MSDUs are not present, then it can be the case that only 2 addresses are available for the MPDU. FIG. 30 illustrates such possible Wi-Fi 8 MAC Headers, according to some embodiments, e.g., with only Address 1 and Address 2 present, and with separate ICF use to provide protection for MAC header signaling. FIG. 31 illustrates a further possible Wi-Fi 8 MAC Header scenario, in which Addresses 1 and 2 can be removed from the MAC headers, and instead carried only in PC and/or ICF/ICR frames. For use of such a MAC Header format, it can be the case that multi-user (MU) transmissions are initiated with ICF/ICR exchange. FIG. 32 is a table indicating possible MAC Header length differences per MPDU among the various possible MAC Header formats of FIGS. 28-31, according to some embodiments. FIG. 33 illustrates aspects of an example scenario for A-MPDU aggregation with A-MSDU, while FIG. 34 illustrates an example A-MSDU frame format that includes destination address (DA) and source address (SA) information, according to some embodiments.

Such a new addressing format can thus potentially provide shorter overall MAC headers, while remaining legacy compatible, e.g., as it may be the case that the NAV location does not change. The format of FIG. 30 can have Address1 and Address2 in the same location as in legacy formats, and while the format of FIG. 31 can have varying address fields, STAs may still be able to detect whether the MPDU is addressed to them. Note that it may be the case that the formats of FIGS. 30-31 do not contain MAC Header integrity protection, e.g., as such protection can be provided via ICF/ICR/PC. These MAC headers can have fixed size, with potentially faster and simplified processing, and can potentially be more private, e.g., with fewer or no STA specific parameters.

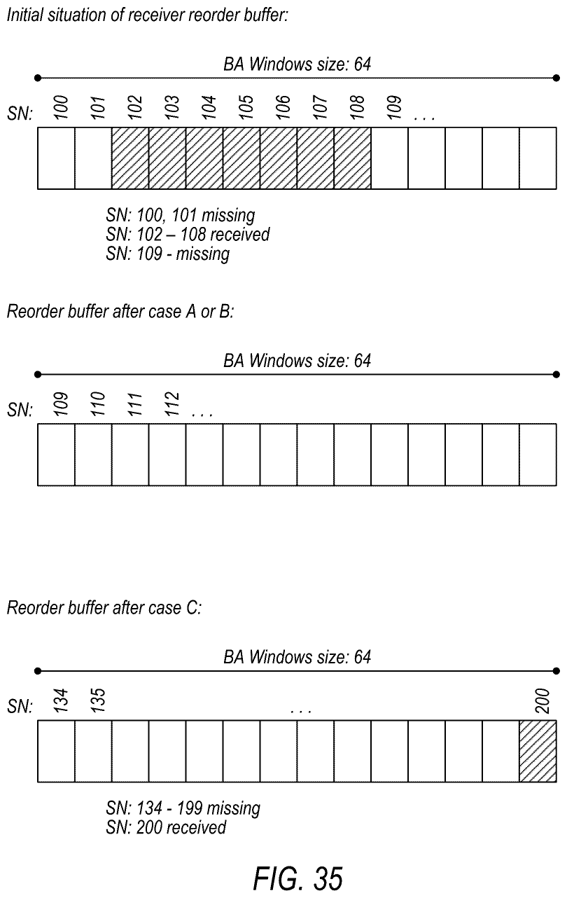

FIG. 35 illustrates aspects of possible receiver reorder buffer handling in various circumstances, according to some embodiments. The transmitted can control the receiver's reorder buffer, which can include moving the reorder buffer forward by various schemes. In the initial receiver reorder buffer situation of FIG. 35, SN 100, 101 are missing, SN 102-108 are received, and SN 109 onward are missing. In a first case (“Case A”), a BAR frame with start SN 105 is received. In this case, the reorder buffer is moved to start from SN 105; the reorder buffer at this point contains consecutive received frames, and the SN starts from 109, with MPDUs with SN 100 and 101 lost. In a second case (“Case B”), MPDUs with SN 100 and 101 are received. In this case, all received MPDUs with consecutive SN values are moved to application and removed from the reorder buffer; no frame loss occurs, and the reorder buffer receives MPDUs from SN 109. In a third case (“Case C”), an MPDU with SN 200 is received. The received frame is the largest received frame in the reorder buffer; received frames 102-108 are forwarded to the application, frames 100, 101, and 109-133 are permanently missed, because the receiver moves reception forward and away from these frames. The receiver can still receive MPDUs with SN higher than 136 (e.g., 200-64). Absent largest SN protection such as described herein, the receiver may thus have no means to recover from the MPDU with the large SN, even if it can detect the frame to be fake.

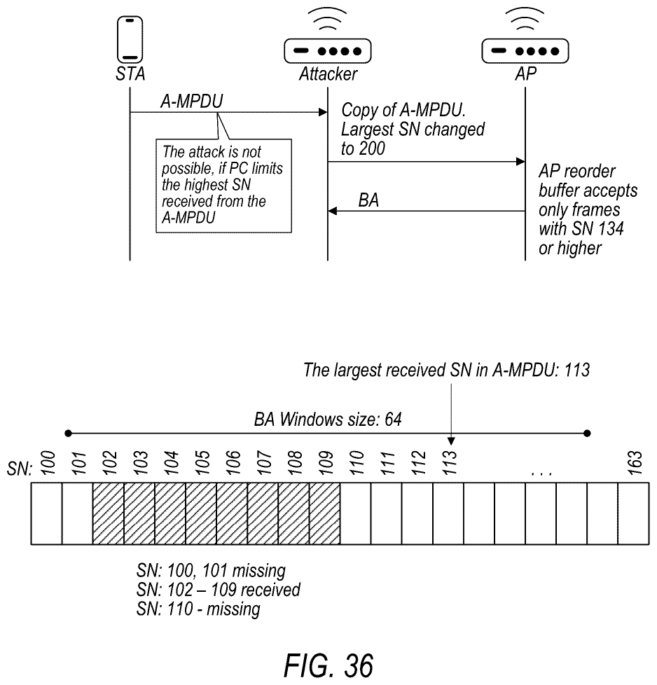

FIG. 36 illustrates aspects of a possible attack scenario with large SN that can be prevented using protected largest SN signaling such as described herein, according to some embodiments. As shown, in the illustrated scenario, an attacker intercepts an A-MPDU and transmits a copy with largest SN changed intending to cause the AP to only accept frames with SN 134 or higher. However, the PC aggregated to the A-MPDU signals the largest SN that is received in the A-MPDU, based on which the modified SN in the MAC header of the MPDU is not received, e.g., since it is larger than the largest SN indicated in the PC frame. For example, in the illustrated scenario, the protected indication of the largest received SN in the A-MPDU is 113, and the receiver correspondingly discards MPDUs with SN>113 from the A-MPDU.

Thus, there can be numerous potential benefits to supporting PPDU-level integrity protection, according to various embodiments, which could include providing a similar protection level as MPDU-level MAC Header integrity protection without need for changes to the MAC Header format, or even with the possibility to shorten MAC headers for increased spectral efficiency, such that very little overhead is added to PPDUs, and obtaining such protection with a reduced number of integrity calculations needed, such that AP and STA implementations can potentially be simplified, and such that additional padding times for MIC calculations may be possible, among other possible benefits.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., an AP 104 or a STA 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for operation in wireless communication, comprising:
receiving first data;
generating a first one or more media access control (MAC) protocol data units (MPDUs) that include the first data;
generating a first control frame that comprises first MAC header content associated with the first one or more MPDUs, first packet number information for the first control frame, first sequence number range information for the first one or more MPDUs, and first integrity protection information for the first MAC header content, first packet number information, and first sequence number range information;
transmitting the first control frame; and
transmitting the first one or more MPDUs.

2. The method of claim 1,
wherein the first control frame and the first one or more MPDUs are transmitted as an aggregated MPDU (A-MPDU) in one physical layer protocol data unit (PPDU).

3. The method of claim 1,
wherein the first control frame comprises an initial control frame (ICF) or initial control response (ICR) that is transmitted as a first physical layer protocol data unit (PPDU),
wherein the first one or more MPDUs are transmitted in an aggregated MPDU (A-MPDU) as a second PPDU.

4. The method of claim 1,
wherein a MAC header associated with the first one or more MPDUs is generated with one or more reserved values for the first MAC header content included in the first control frame.

5. The method of claim 1,
wherein the first MAC header content included in the first control frame comprises at least one of:
a more data (MD) field;
a power management (PM) field;
an end-of-service-period (EOSP) field; or
a high throughput (HT) control field.

6. The method of claim 1,
wherein the first sequence number range information comprises an indication of a largest MPDU sequence number for the first one or more MPDUs.

7. The method of claim 1,
wherein first sequence number range information comprises an indication of a largest MPDU sequence number for each of multiple traffic identifiers (TIDs) for the first one or more MPDUs.

8. The method of claim 1, wherein the method further comprises:
receiving second data;
generating a second one or more MPDUs comprising the second data, wherein the second one or more MPDUs have at least one sequence number outside of a sequence number range indicated by the first sequence number range information;
generating a second control frame that includes second MAC header content associated with the second one or more MPDUs, second sequence number range information for the second one or more MPDUs, and second integrity protection information for the second MAC header content and second sequence number range information;
transmitting the second control frame; and
transmitting the second one or more MPDUs.

9. The method of claim 8,
wherein the first control frame, the first one or more MPDUs, the second control frame, and the second one or more MPDUs are transmitted as an aggregated MPDU (A-MPDU) in one physical layer protocol data unit (PPDU).

10. A processor comprising memory configured to cause the processor to perform operations comprising:
receiving data;
generating one or more media access control (MAC) protocol data units (MPDUs) that include the data; and
generating a control frame that comprises MAC header content associated with the one or more MPDUs, sequence number range information for the one or more MPDUs, and integrity protection information for the MAC header content and sequence number range information.

11. The processor of claim 10, wherein the memory is further configured to cause the processor to perform operations comprising:
aggregating the control frame and the one or more MPDUs into an aggregated MPDU (A-MPDU) that is configured for transmission in one physical layer protocol data unit (PPDU).

12. The processor of claim 10,
wherein the control frame comprises an initial control frame (ICF) or initial control response (ICR) that is configured for transmission in a first physical layer protocol data unit (PPDU),
wherein the one or more MPDUs are configured for transmission as an aggregated MPDU (A-MPDU) in a second PPDU.

13. The processor of claim 10,
wherein the MAC header content included in the control frame comprises at least one of:
a more data (MD) field;
a power management (PM) field;
an end-of-service-period (EOSP) field; or
a high throughput (HT) control field.

14. The processor of claim 10,
wherein the first sequence number range information comprises an indication of a largest MPDU sequence number for each of one or more traffic identifiers (TIDs) for the one or more MPDUs.

15. A wireless device, comprising:
one or more antennas;
one or more radios operably coupled to the one or more antennas; and
a processor operably coupled to the one or more radios;
wherein the wireless device is configured to:
generate one or more media access control (MAC) protocol data units (MPDUs);
generate a control frame that comprises:
at least one of a more data (MD) field, a power management (PM) field, an end-of-service-period (EOSP) field, or a high throughput (HT) control field for the one or more MPDUs,
sequence number range information for the one or more MPDUs; and
integrity protection information;
transmit the control frame; and
transmit the one or more MPDUs.

16. The wireless device of claim 15,
wherein the control frame and the one or more MPDUs are transmitted as an aggregated MPDU (A-MPDU) in one physical layer protocol data unit (PPDU).

17. The wireless device of claim 15,
wherein the control frame comprises an initial control frame (ICF) or initial control response (ICR) that is transmitted as a first physical layer protocol data unit (PPDU),
wherein the one or more MPDUs are transmitted in an aggregated MPDU (A-MPDU) as a second PPDU.

18. The wireless device of claim 15,
wherein the one or more MPDUs are generated according to a format version that includes a one octet frame control field and a one octet Quality of Service (QOS) control field at frame start and a duration field two octets after frame start.

19. The wireless device of claim 15,
wherein the one or more MPDUs are generated according to a format version that includes address 1 and address 2 indications for identifying a transmitter and a receiver for the one or more MPDUs in MAC headers of the one or more MPDUs and address 3 and address 4 indications for identifying network end points in aggregated MAC service data unit (A-MSDU) headers for the one or more MPDUs.

20. The wireless device of claim 15,
wherein the control frame includes address indications for identifying a transmitter and a receiver for the one or more MPDUs,
wherein the one or more MPDUs are generated according to a format version that does not includes address indications for identifying a transmitter and a receiver for the one or more MPDUs.
